(19) United States
(12) Patent Application Publication
(10) Pub. No.: US 2010/0138185 A1
(43) Pub. Date: Jun. 3, 2010

(54) DEVICE FOR THREE-DIMENSIONALLY MEASURING BLOCK AND SYSTEM HAVING THE DEVICE

(75) Inventor: Hyun KANG, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/491,643

(22) Filed: Jun. 25, 2009

(30) Foreign Application Priority Data
Dec. 2, 2008 (KR) 10-2008-0120914
Mar. 12, 2009 (KR) 10-2009-0021206

(51) Int. Cl. G01B 11/03; G06F 15/00

(52) U.S. Cl. 702/152

(57) ABSTRACT

The 3D measurement device for measuring a block includes: a first sensor for sensing location information of itself; one or more second sensors for measuring relative distances from the block; and an absolute location calculation unit for calculating absolute location values at respective points of the block using the location information sensed by the first sensor and the relative distances measured by the second sensors.

### CROSS-REFERENCE(S) TO RELATED APPLICATION(S)

The present invention claims priority of Korean Patent Application No. 10-2008-0120914, filed on Dec. 2, 2008, and No. 10-2009-0021206, filed on Mar. 12, 2009, which is incorporated herein by reference.

### FIELD OF THE INVENTION

The present invention relates to a device and system for three-dimensionally measuring a block, and, more particularly, to a 3D measurement device measuring blocks and a 3D measurement system having the 3D measurement device capable of measuring blocks with massive faces, in small space.

### BACKGROUND OF THE INVENTION

In order to build a ship, construction methods of producing large-scale blocks, moving and joining the blocks together using extra-large cranes and then completing ships have been practiced. The large-scale blocks bring the advantage of reducing total processes but, when the blocks are actually joined, they are deformed due to welding, corrosion and heat, thereby causing errors which deviate from design dimensions to result in difficulty in joining the blocks together.

The accurate measurement of blocks is very important for shipbuilding so that various measuring methods have been proposed. In the early stage of shipbuilding, shipbuilders directly measured in pairs each block one by one. Later, a measuring method employed in construction work, in line with the development of measuring technology, was introduced to a field of shipbuilding. However, since these methods require many persons and a large number of processes, so recently, a distance measuring method using a laser is being used.

The distance measuring methods include a method using a laser guide to measure the opposite side and a measuring method using no-target pulse laser total station.

In addition, there is a method which converts point data collected using the above distance measuring methods into a 3D model.

Since these conventional methods require a specific space between a target and a measuring device, they are not effective on domestic shipbuilding environment in which very small spaces are provided as compared with considerably many blocks.

### SUMMARY OF THE INVENTION

In view of the above, the present invention provides a 3D measurement device capable of measuring locations at respective points of each joining surface of a block.

Further the present invention provides a 3D measurement system capable of measuring a block having a massive joining surface even in small space by employing the 3D measurement device.

In accordance with one aspect of the present invention, there is provide a 3D (three-dimensional) measurement device for a block, including:

a first sensor for sensing location information of itself;

one or more second sensors for measuring relative distances from the block; and

an absolute location calculation unit for calculating absolute location values at respective points of the block using the location information sensed by the first sensor and the relative distances measured by the second sensors.

In accordance with another aspect of the present invention, there is provide a 3D measurement system for a block, including:

a 3D measurement device for three-dimensionally measuring blocks;

a transfer unit for two-dimensionally moving the 3D measurement device; and

a fastening unit for fastening the transfer unit to the block.

### BRIEF DESCRIPTION OF THE DRAWINGS

The above features of the present invention will become apparent from the following description of embodiments given in conjunction with the accompanying drawings, in which:

FIG. 1 is a perspective view showing a 3D measurement system for a block in accordance with the present invention;

FIG. 2 is a perspective view showing a 3D measurement device in accordance with the present invention; and

FIG. 3 is a diagram showing an example of the 3D measurement system being applied to a block in accordance with the present invention.

### DETAILED DESCRIPTION OF THE PREFERRED EMBODIMENTS

Hereinafter, embodiments of the present invention will be described in detail with reference to the accompanying drawings so that they can be readily implemented by those skilled in the art.

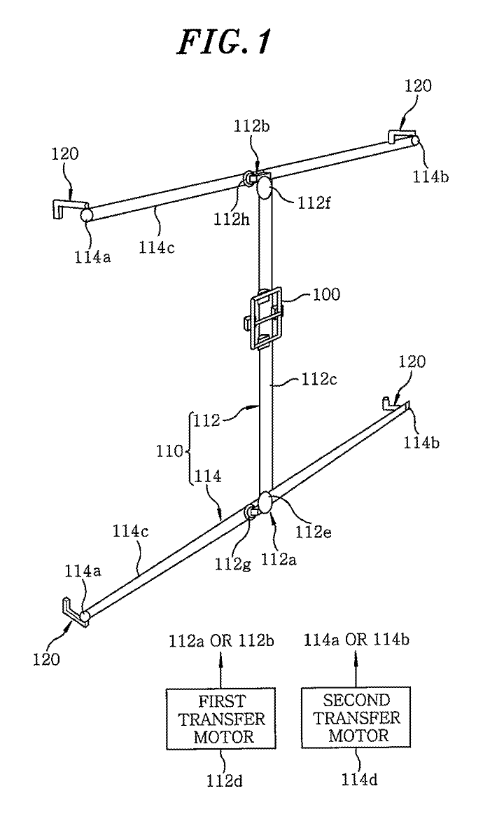

FIG. 1 is a perspective view showing a three-dimensional (3D) measurement system for joining blocks together in accordance with the present invention. The 3D measurement system includes a 3D measurement device 100 for three-dimensionally measuring blocks, a transfer unit 110 for two-dimensionally moving the 3D measurement device 100, and a fastening unit 120 for fastening the transfer unit 110 to a block. Here, the transfer unit 110 includes a first transfer unit 112 for transferring the 3D measurement device 100 along the Y-axis and a second transfer unit 114 for transferring the first transfer unit 112 along the X-axis.

The first transfer unit 112 includes first and second wheels, 112a and 112b, installed in the direction of the Y-axis, and a first wire 112c whose one side is fastened to the 3D measurement device 100. The first wire 112c is installed onto the first and second wheels, 112a and 112b, so as to perform endless track movement. The first transfer unit 112 may further include a first transfer motor 112d for providing rotating force to the first or second wheel, 112a or 112b. The 3D measurement device 100 fastened to the first wire 112c may be transferred in the direction of the Y-axis by rotating the first or second wheel, 112a or 112b, using the first transfer motor 112d.

Each of the first and second wheels, 112a and 112b, of the first transfer unit 112 includes rotating elements 112e and 112f and connecting elements 112g and 112h connected to the rotating elements 112e and 112f, respectively. The rotating elements 112e and 112f are rotated by the first transfer motor 112d, enabling the first wire 112c to perform endless track movement. The connecting elements 112g and 112h are connected to the second transfer unit 114 so that they move the first transfer unit 112 in the direction of the X-axis.

The second transfer unit 114 includes third and fourth wheels, 114a and 114b, installed in the direction of the X-axis, second wires 114c fastened to the connecting elements 112g and 112h of the first transfer unit 112, and a second transfer motor 114d providing rotating force to the third or fourth wheels, 114a or 114b. The second wire 114c performs endless track movement according to the operation of the third and fourth wheels, 114a and 114b. The third and fourth wheels, 114a and 114b, are connected to the connecting elements 112g and 112h of the first transfer unit 112, via the second wires 114c.

As rotating force is transferred to the third or fourth wheels, 114a or 114b, by the second transfer motor 114d, the second wires 114c performs endless track movement. According to the endless track movement of the second wires 114c, the first transfer unit 112 is moved in the direction of the X-axis by the connecting elements 112g and 112h of the first transfer unit 112, so that the 3D measurement device 100 connected to the rotating elements 112e and 112f of the first transfer unit 112 is moved in the direction of the X-axis.

The fastening unit 120 includes a plurality of fastening pieces for connecting the third and fourth wheels, 114a and 114b, to a block so that they can be rotatable. The plurality of fastening pieces are fastened at joining surface of the block, that is, a part of the block that is joined with another block.

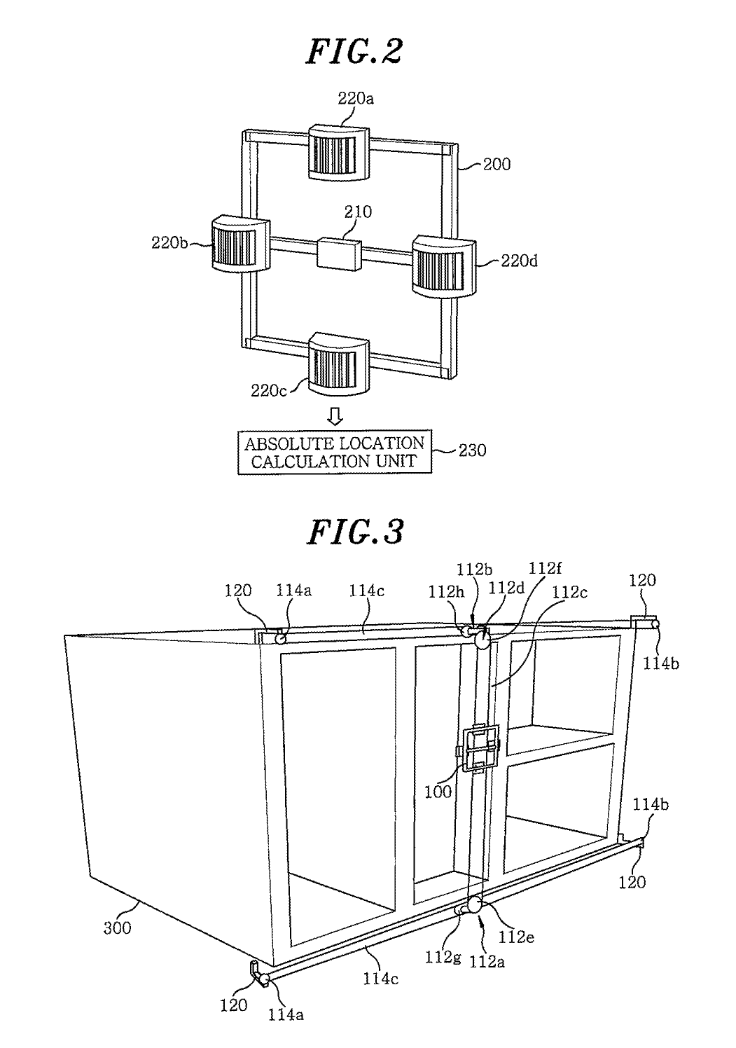

FIG. 2 is a perspective view showing a 3D measurement device. The 3D measurement device 100 includes a frame 200 connected to the first transfer unit 112 of the transfer unit 110, a first sensor 210 installed on the frame 200, a plurality of second sensors 220a, 220b, 220c and 220d installed on upper, lower, left, and right frame of the first sensor 210, and an absolute location calculation unit 230. The first sensor 210 senses location information of itself, for example, data on latitude, longitude and altitude on the earth. The second sensors 220a, 220b, 220c and 220d measure the relative distance between the block and the 3D measurement device 100. The absolute location calculation unit 230 calculates absolute location values at respective points of the block, using the location information sensed by the first sensor 210 and the relative distance measured by the second sensors 220a, 220b, 220c and 220d.

The first sensor 210 used in the present invention is a CDGPS (carrier-phase differential global positioning sensor). A CDGPS has an error equal to or less than several mm, which is close to the error of the existing manual measuring method.

Furthermore, the CDGPS may sense data on the latitude, longitude and altitude of the 3D measurement device 100 by receiving signals from a differential signal station installed on site where blocks are assembled together, for example, a shipbuilding site, or from an adjacent DGPS signal station.

The second sensors 220a, 220b, 220c and 220d are laser distance measuring sensors, and have accuracy and fast response speed to the extent that they are used for factory automation or a car safety device.

It will be described with reference to FIG. 3 how the 3D measurement system of the present invention measures absolute location values at respective points of the block.

FIG. 3 is a diagram showing an example of the 3D measurement system being applied to a block in accordance with the present invention. The fastening pieces of the fastening unit 120 are mounted on a surface of a block 300 to be measured, and the 3D measurement device 100 is connected to the first wire 112c of the first transfer unit 112.

The rotating element 112e or 112f connected to the first or second wheel, 112a or 112b, is rotated by operating the first or second wheel, 112a or 112b, of the first transfer unit 112 through the operation of the first transfer motor 112d. As the rotating element 112e or 112f is rotated, the 3D measurement device 100 is moved in the direction of the Y-axis. Furthermore, through the operation of the second transfer motor 114d, the third or fourth wheels, 114a or 114b, are operated, so that the connecting elements 112g and 112h connected to the second wires 114c of the second transfer unit 114 is moved in the direction of the X-axis. Accordingly, the 3D measurement device 100 is moved in the direction of the X-axis as well as the Y-axis. While moving along the X-axis and Y-axis, the 3D measurement device 100 senses data, i.e. latitude, longitude and altitude data using the first sensor 210 and measures relative distances between the location of the 3D measurement device 100 and the block 300 using the second sensors 220a, 220b, 220c and 220d, at respective points of each joining surface of the block 300. The sensed data and the relative distances are delivered to the absolute location calculation unit 230.

Next, the absolute location calculation unit 230 calculates absolute location values at respective points of the block 300 using the relative distances and the sensed latitude, longitude and altitude data. The absolute location values are expressed as the WGS84 coordinates, and are three-dimensionally modeled through a post-processing process.

The present invention may reduce the number of processes of measuring blocks and may improve stability of measuring work by providing a 3D measurement device for joining large-scale blocks and a 3D measurement system having the 3D measurement device.

In addition, the 3D measurement system of the present invention occupies small space compared to other measurement devices, by combining a block with the 3D measurement device using a transfer unit and a fastening unit, thereby achieving desirable effect on shipbuilding site.

Further, the present invention may be applied to inspection equipments for inspecting the completion of blocks and the overall appearance of a complete ship because 3D modeling for luxury passenger ships and merchant ships is being attempted. Moreover, the present invention may be used for evaluation of the assemblability of blocks because the blocks have recently been employed to construction works.

While the invention has been shown and described with respect to the embodiments, it will be understood by those skilled in the art that various changes and modifications may be made without departing from the scope of the invention as defined in the following claims.

What is claimed is:

1. A 3D (three-dimensional) measurement device for a block, comprising:
a first sensor for sensing location information of itself;
one or more second sensors for measuring relative distances from the block; and
an absolute location calculation unit for calculating absolute location values at respective points of the block using the location information sensed by the first sensor and the relative distances measured by the second sensors.

2. The 3D measurement device of claim 1, wherein the first sensor is a CDGPS (carrier-phase differential global positioning sensor) which receives signals from a differential signal station located within a preset range or from a DGPS signal station and senses the location information.

3. The 3D measurement device of claim 1, wherein the second sensors are installed on upper, lower, left and right side of the first sensor, respectively, while being spaced apart from the first sensor.

4. A 3D measurement system for a block, comprising:
a 3D measurement device for three-dimensionally measuring blocks;
a transfer unit for two-dimensionally moving the 3D measurement device; and
a fastening unit for fastening the transfer unit to the block.

5. The 3D measurement system of claim 4, wherein the 3D measurement device includes:
a frame connected to the transfer unit;
a first sensor installed on the frame and for sensing location information of itself;
one or more second sensors installed on the frame and for measuring relative distances from the block; and
an absolute location calculation unit for calculating absolute location values of the block using the location information sensed by the first sensor and the relative distances measured by the second sensors.

6. The 3D measurement system of claim 5, wherein the first sensor is a CDGPS which receives signals from a differential signal station located within a preset range or from a DGPS signal station and senses the location information.

7. The 3D measurement system of claim 5, wherein the second sensors are installed on upper, lower, left and right side of the first sensor, respectively.

8. The 3D measurement system of claim 5, wherein the second sensors are laser distance measuring sensors.

9. The 3D measurement system of claim 4, wherein the transfer unit includes:
a first transfer unit for transferring the 3D measurement device in the direction of the Y-axis; and
a second transfer unit for transferring the first transfer unit in the direction of the X-axis.

10. The 3D measurement system of claim 9, wherein the first transfer unit has:
a first and second wheel installed in the direction of the Y-axis; and
a first wire, whose one side is fastened to the 3D measurement device 100, installed on the first and second wheel to be able to perform endless track movement 3D measurement device.

11. The 3D measurement system of claim 10, wherein the first or second wheel contains:
rotating elements connected to the first wire; and
connecting elements linking the rotating elements to the second transfer unit.

12. The 3D measurement system of claim 10, wherein the first transfer unit further has a first transfer motor for providing rotating force to the first or second wheel.

13. The 3D measurement system of claim 9, wherein the second transfer unit has:
third and fourth wheels installed in the direction of the Y-axis; and
second wires, whose one sides are fastened to the first transfer unit, installed on the third and fourth wheels to be able to perform endless track movement.

14. The 3D measurement system of claim 13, wherein the second transfer unit further has a second transfer motor for providing rotating force to the third or fourth wheels.

15. The 3D measurement system of claim 4, wherein the fastening unit includes a plurality of fastening pieces, by which the third and fourth wheels is fastened to the block in the way they can be rotated.

16. The 3D measurement system of claim 4, wherein the fastening unit fastens the transfer unit to a surface of the block to be joined with another block.
